(19) United States
(12) Patent Application Publication
(10) Pub. No.: US 2007/0109096 A1
(43) Pub. Date: May 17, 2007

(54) Global tracking and communications device

(76) Inventor: Jeremy Breedlove, Kuttawa, KY (US)

Correspondence Address: STOCKWELL & SMEDLEY, PSC, 861 CORPORATE DRIVE, SUITE 200, LEXINGTON, KY, 40503, US

(21) Appl. No.: 11/515,257

(22) Filed: Sep. 1, 2006

Related U.S. Application Data
(60) Provisional application No. 60/715,230, filed on Sep. 8, 2005.

(51) Int. Cl. B60R 25/00; G05B 19/00

(52) U.S. Cl. 340/5.72; 340/539.13; 342/457; 307/10.3

(57) ABSTRACT

A tracking and communication system, in which a device attaches to heavy equipment and enables remote monitoring of that equipment, is disclosed. The device is highly configurable with extensive communication capabilities, and is integrated within a larger communications network that is accessible by customers via the Internet.

### CROSS-REFERENCE TO RELATED APPLICATIONS

This application claims priority to U.S. Provisional Application No. 60/715,230, which was filed on Sep. 8, 2005.

### FIELD OF THE INVENTION

This invention relates generally to tracking devices, and more specifically to a device which attaches to equipment and enables remote monitoring of that equipment.

### BACKGROUND OF THE INVENTION

Currently, at construction sites, among other locations, theft or misuse of heavy mechanical equipment is a significant problem. Additionally, it is difficult to determine usage and depreciation of a specific piece of equipment. The present invention provides a means for resolving these and other problems.

### SUMMARY OF THE INVENTION

It is an object of the present invention to provide a tracking and anti-theft-product for bulldozers, tractors, bobcats, and other heavy industrial equipment at construction sites, although the present invention should not be considered as limited exclusively thereto. For example, the present invention can also be applied to rental cars.

A tracking device attached directly to the ignition area of the equipment prevents anyone from turning on the bulldozer without a touch-contact of an electronic card or punching in a code, among other functions. The overall product including customized software in wireless communication with the tracking device gives details about how many hours/day a bulldozer or other heavy equipment was used. These and other objects and advantages of the invention will become readily apparent as the following description is read in conjunction with the accompanying drawings.

### BRIEF DESCRIPTION OF THE DRAWINGS

FIG. 1 is a perspective view of an exemplary embodiment of the present invention;

FIG. 2 is an exemplary embodiment of the device which attaches to the equipment, of the present invention.

FIGS. 3 and 4 are exemplary screen captures of one possible implementation of the software of FIG. 1; and

FIG. 5 is a flowchart showing the software behavior of the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

Within the present invention, a tracking device attached directly to the ignition area of a unit of heavy equipment, such as a bulldozer, prevents the bulldozer from being started without a touch-contact of an electronic card or punching in a code, among other functions. The tracking system, including customized software in wireless communication with the tracking device, gives details about how many hours/day a bulldozer or other heavy equipment was used. Such information can be useful for equipment rental companies and owners (tax records, equipment depreciation schedules, 500 hour maintenance checkups, etc).

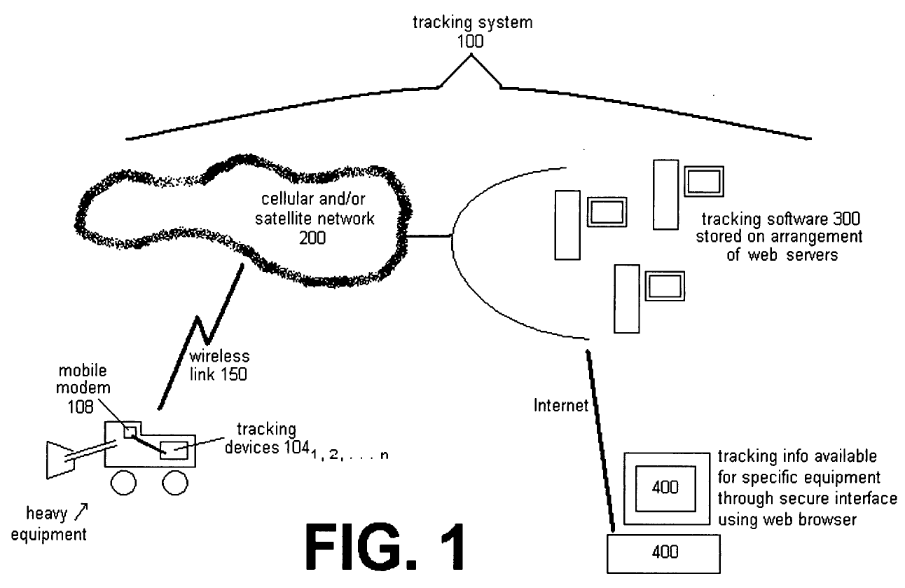

An exemplary embodiment of the present invention is shown in FIG. 1, in which a tracking system 100 is shown. Within the system 100, a series of tracking devices 104₁₋ₙ are shown attached to units of heavy construction or other rental equipment. The tracking device 104 communicates with a cellular and/or wireless network 200 through a wireless link 150 using a wireless mobile modem 108, which in turn shares information with tracking software 300. The tracking software 300 manages and stores the information in a variety of formats, specifically customized to suit the needs of the end users. An end user with a password can view and store info about her heavy equipment using a computer loaded with end-user software 400 communicating with the tracking software 300 through a secure Internet link.

The tracking software can be compiled using any of a variety of web server products, including but not limited to Active Server Page (ASP), Personal Home Page (PHP), or Cold Fusion. Additionally, the tracking software 300 can be compiled to be portable, and thus usable within a company's own Intranet or Virtual Private Network (VPN).

The cellular and/or satellite network 200 can use either GSM, CDMA, or a hybrid of the two, as well as other configurations not explicitly described herein. The tracking device 104 can communicate with the wireless mobile modem 108 corresponding thereto via any of serial, Universal Serial Bus (USB), Ethernet, or other means. Alternatively, the mobile modem 108 can be contained or incorporated entirely or partially within the tracking device 104.

The end-user software 400 could a web browser, although other software implementations are contemplated within the spirit and scope of the present invention. The tracking software 300 can be stored on a cluster or group of servers, to achieve the redundancy that leads to more effective web-hosting with a higher up-time.

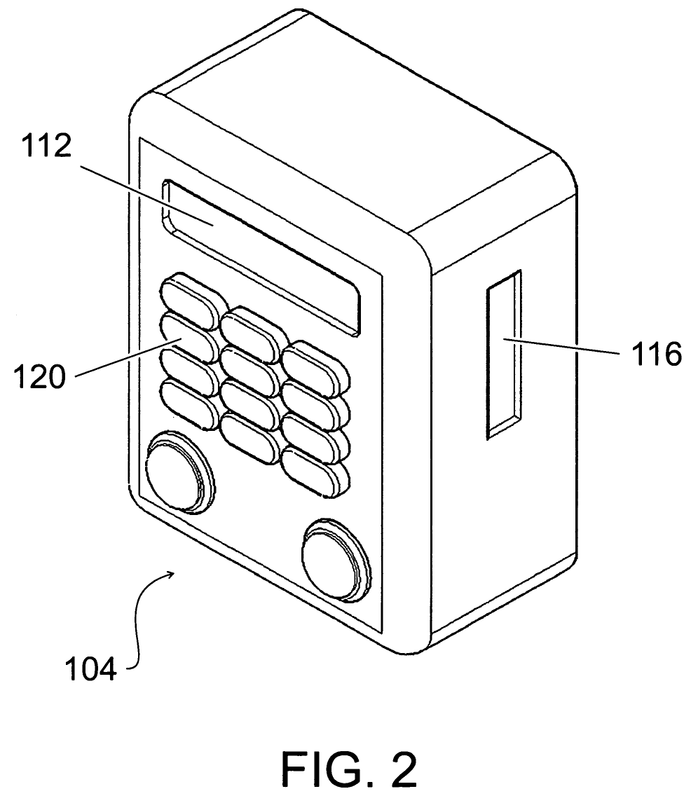

As shown in FIG. 2, the tracking device 104 comes with a red button (stop), a green button (go), a numeric keypad, and a character display 112. The tracking system 100 of the present invention can be implemented with a GPS/cellphone chipset, although the present invention should not be considered as limited to this implementation only. A GPS/cellular chipset allows for send and receive data through a cellular and/or satellite communication network 200, which could be hosted by a variety of vendors.

Data can be sent from the tracking device 104 via, for example, the numeric keypad 120, swipe of card or other mechanism, or proximity-contact through the reader 116. That data will be sent through the network 200 to the group of servers 300, where it is accessible by the end-user software 400 through a secure Internet link. A user can then view when the product or the piece of equipment was started stopped and where it is on total hours on that equipment, as well ignition information for turning it on and off, especially considering a theft problem with this type of equipment.

If a user enters a code, or swipes or proximity-touches a card or other reading mechanism at the tracking device 104, and that card is denied, the equipment will not start. The card acts like a user name and password for a specific unit of equipment. An embodiment of the tracker exists in which no data entry is required on the numeric keypad 120. Instead, the operator only has to put a card near the data reader 116, but need not do any manual data input.

The data reader 116 could be RFID, Universal Product Code (UPC) bar code, cards with magnetic strips, proximity cards, smart chip, USB, Bluetooth, or other implementation. Regardless of how the userlD is entered, if the card or input device is denied, the display 112 of the tracking device 104 can be configured to show “denied”.

As suggested in FIG. 2, the text display 112 can have a two or three line capability, although other sizes are possible, and will be readable in all outdoor conditions regardless of cold temperatures, snow, dirt, etc. The display 112 may be an LCD type, although other implementations are also contemplated, so that the present invention should not be considered as limited exclusively thereto.

The tracking device 104 can also have a rubber mount, a rubber sealing point, and be entirely weather sealed. The buttons for the numeric keypad 120 are also entirely weatherized, and there will be a gasket (not shown) around the display 112. The tracker device 104 is built to military grade, can withstand temperatures of −40 F. to +167 F., as well as a vibration drop of a predetermined distance that is established by military-grade specifications.

The tracker device 104 obviates the need for ignition keys, as it is wired directly to the ignition system of a unit of equipment. Many heavy equipment companies are not rigorous in their manufacturing of ignition keys. Thus, at present, without the present invention, a thief could take an ignition key now that's made by a heavy equipment manufacturer, visit a specific city, and can steal 100 pieces of machinery in an hour. This is partly because most keys for heavy equipment are somewhat standardized, and often fit many units of equipment. It also takes a while for an owner to notice that a piece of equipment has been stolen. The owners don't know where it is, how it's doing it and they can't just put match locks underneath it, then they would have to have 1,000 match locks for all employees, and an identical key would probably work for all of them.

Conversely, the tracking device 104 within the present invention is connected to directly to an ignition system and the battery. The tracking device 104 will have a battery back up. If a user doesn't have an actual card, the numeric buttons within the tracking device 104 can be set up to not do anything, or perhaps only say “denied”. If it's not a registered card or activated card from the present invention, the equipment will not work.

Optimally, the provider of the cellular and or/satellite communications network 200 will have the capability of digital, analog, and GPS all built into a single embodiment of the tracking device 104 and mobile modem 108. This is important because not all cell carriers enable access to GPS coordinates. Accordingly, it is desired to avoid a situation where a communications carrier that has their cell service is completely dead in the area, which can't send and receive the data. That means a user would have to wait to get the unit of heavy equipment, and the tracking device 104 attached thereto, back in the cellular range. The present invention could also conceivably be implemented within a satellite network.

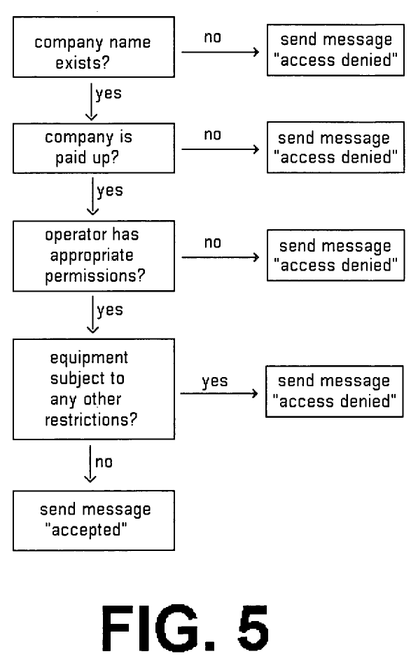

Using the present invention, a customer could say to an equipment rental company that she needs 5 magnetic cards (or other input devices) for each bobcat, for example. The rental company, using the present invention, will program the five cards with the customer's company name and IDs of for example five specific operators. These operators then touch those cards to the equipment. When that happens, the tracking software 300 will check various parameters, as shown in FIG. 5.

When a operator attempts to access a unit of equipment, the tracking software 300 will check the company name on the card against information within a payment database that is part of the tracking software 300. Some exemplary test might be: Does this company exist within the database? Next, are they paid up? Next, is this operator still permitted to operate this equipment? Next, has some other entity requested that this equipment be shut down and inaccessible? Other choices could also be included within the tracking software 300 of the present invention. If all factors check out, the tracking software 300 relays a message to the tracking device 104 to enable access and post a message to the display 116 that says “accepted”, or some other words to that effect..

For an operator to access a unit of equipment, the end-user software 400 is not necessary. However, by accessing a back end, database portion of the tracking software 300 through the end-user software 400, a specific company's account information can be pre-entered into, for example, a rental agency's computer systems.

A user could activate a tracker device 104 by, for example, entering a number on the keypad 120, or touching the data reader 116 with a card or other device. The system 100 will then recognize that a specific construction company has an account with a construction equipment rental company, so that will activate that tracker device 104 for a specific period such as one week. Thus, a general contractor with access to any web browser (acting as the end-user software 400) could have the capability to enable specific equipment for pre-determined time periods, and to track that enablement and subsequent usage.

One possible example would be a general contractor needing to run 15 pieces of equipment used by 10 separate sub-contractors. That general contractor would give out 10 cards, where each one of those cards will start each one of those units of equipment.

That general contractor could then view the tracking software 300 and look at their report for a specific time period. If a unit of heavy equipment was damaged on a specific day, that general contractor could query the software to determine all users of that unit on a specific day. In other words, the end-user software 400 would show every sub-contractor who touched their card onto that unit. The general could then collect damages directly from the sub-contractor who damaged the equipment.

On either a rental basis or general contractor basis, an entity using the system 100 of the present invention can sub-lease their own equipment as a way of alleviating their costs. Suppose a backhoe was not in use at a specific time, yet the general contractor was still paying rent. This occurs often at construction sites. Then suppose a subcontractor from a nearby site approaches the general and request use of the backhoe for 2 hours. Using the system 100 of the present invention, the general contractor reduced his rental costs by two hours. Also, if the backhoe comes back with a flat tire or problem, it would be easier to identify the sub-contractor who flattened the tire. In this situation, if the general did not employ the system 100 of the present invention, the general would be responsible for the repair costs with no easy way to identify a responsible party.

Instead, using the present invention, a general contractor can rent her equipment to a subcontractor. This provides a convenient way to manage costs on the job because she could have fifteen different people using her expensive equipment, yet still know exactly how to track it.

Software Interface

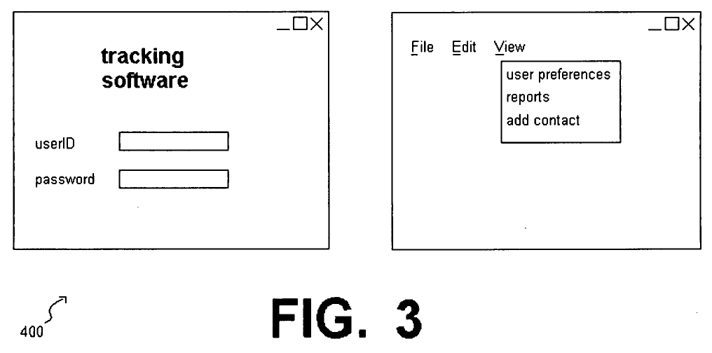

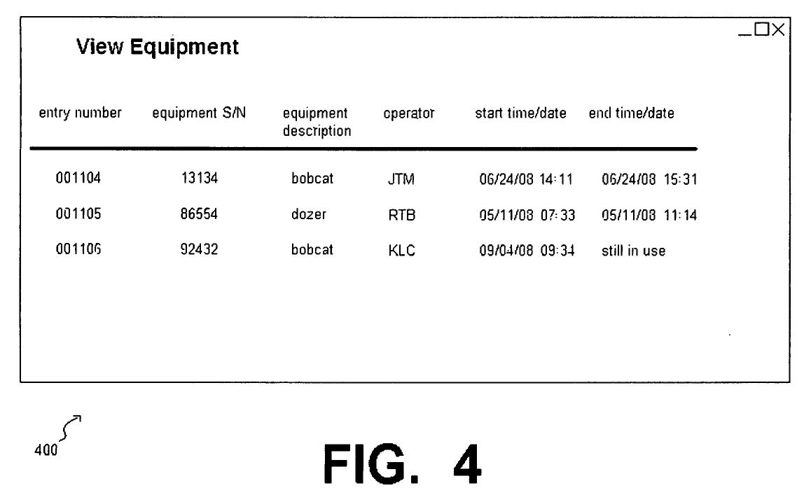

FIGS. 3 and 4 show examples of user interface screens by which a user could make such queries regarding her equipment. FIG. 3 shows an exemplary logon screen, and also an exemplary list of selectable options. Meanwhile, FIG. 4 shows an exemplary partial listing of equipment. It is to be noted that the embodiments shown in FIGS. 3 and 4 are but for exemplary purposes only, so that the present invention should not be considered as limited exclusively thereto.

Diesel Considerations

Some heavy equipment runs on diesel fuel. Such diesel machines may require special care during the start-up and ignition process, such as diesel's being warmed up prior to starting because of the glow plugs commonly found on diesel equipment. The display 112 within the tracker device 104 could accommodate such machines by having the main menu have an option labeled “Set Up” or similar expression. The tracker device 104 would then allow a user to set a delayed ignition before they start the unit.

Some ignition delays for diesel engines are 10 seconds. The exact delay could vary, depending on temperature and any other relevant factors. Some pieces of diesel equipment also have an “ether” button on them, to dispense a shot of ether prior to ignition. The tracking device 104 could be configured to accommodate this also.

Software Updates

The present invention provides a solution for automatically downloading software updates. It is well-known that the various protocols for electronic communication change often, which means software must be updated often. With the tracking device 104 being located out in the field, on various construction sites, updating the software modules contained therein could be difficult. To reduce this difficulty, there can be two different memory modules within the tracking device 104. The memory first module would store all the information that's actually programmed only to a specific tracker device 104, such as all its user card-contacts.

Meanwhile, the second memory module would be just for the firmware which is loaded on all tracking devices 104₁₋ₙ (FIG. 1), which may require updating by the tracker company, but not by an end user or customer. Within such a configuration, sending an update to the tracking device 104 through the communication network 200 will not wipe out or erase any of the data carefully stored on the first memory module.

One well-known problem with software updates is as follows. Within a CISCO™ router, for example, after a firmware update, one can lose all their settings and then have to reprogram the entire router. To avoid this problem, updating the tracker device 104 could involve just adding new data at the bottom to the bottom of a memory module, rather than over-writing it entirely. This way, data integrity can be maintained. Also, it is desired to avoid a scenario of calling a customer and saying “we updated your firmware, but now you must go back out there to the construction site and re-input in your serial number, or your company name, all over again”,

The system 100 of the present invention can be implemented with other valuable mobile objects, not just heavy equipment at construction sites. One such example could be rental cars.

It is anticipated that various changes may be made in the arrangement and operation of the system of the present invention without departing from the spirit and scope of the invention, as described in the following claims.

What is claimed is:

1. A system for tracking equipment, comprising:
a plurality of tracking devices, each attached to a single unit of the equipment;
a cellular and/or wireless network connected to the tracking devices through a wireless link and a wireless mobile modem;
a tracking software module connected to the cellular and/or wireless network for managing and storing user, equipment, and accounting information in a variety of formats; and
end-user software communicating with the tracking software through a secure Internet link, for enabling an end user to access the user, equipment, and accounting information;
wherein the tracking software module can be specifically customized to suit the separate needs of a plurality of end users.

2. The system of claim 1, further comprising:
the tracking software is compiled using web server products.

3. The system of claim 2, wherein the web server product is either Active Server Page, Personal Home Page, or Cold Fusion.

4. The system of claim 1, further comprising:
the tracking software is compiled to be portable, and thus usable within a company's own Intranet or Virtual Private Network.

5. The system of claim 1, further comprising:
the cellular and/or satellite network being either GSM, CDMA, or a hybrid of the two.

6. The system of claim 1, further comprising:
the tracking device communicates with the wireless mobile modem corresponding thereto via any of serial, Universal Serial Bus, or Ethernet protocols.

7. The system of claim 1, further comprising:
the mobile modem is contained or partially or entirely incorporated within the tracking device.

8. The system of claim 1, wherein the tracking device further comprises a red button (stop), a green button (go), a numeric keypad, and a character display.

9. The system of claim 8, wherein the tracking device further comprises a data reader.

10. The system of claim 9, wherein the data reader further comprises an RFID reader.

11. The system of claim 9, wherein the data reader further comprises a Universal Product Code bar code reader.

12. The system of claim 9, wherein the data reader further comprises a magnetic card reader.

13. The system of claim 9, wherein the data reader further comprises a proximity card reader.

14. The system of claim 9, wherein the data reader further comprises a smart chip, Universal Serial Bus, or Bluetooth reader.

15. The system of claim 1, further comprising:
the tracking software module is accessible through end-user software via a secure Internet link.

16. The system of claim 15, wherein the end-user software further comprises a browser.

17. The system of claim 1, further comprising:
the tracking software containing customer and equipment data so that an attempt to access a unit of equipment can be denied, so that the unit will not start.

18. The system of claim 1, wherein the tracking device further comprises a GPS/cellphone chipset.

19. The system of claim 1, further comprising:
the tracking software module further comprises a group of servers.

20. The system of claim 1, wherein the character display is readable in all outdoor conditions regardless of cold temperatures, snow, or dirt.

21. The system of claim 1, wherein the tracking device is built to military grade, can withstand temperatures of −40 F. to +167 F.

22. The system of claim 1, wherein the tracking device is wired directly to the ignition system of a unit of equipment and thereby obviates the need for ignition keys.

23. The system of claim 1, further comprising:
the tracking device having a battery back up

24. The system of claim 1, further comprising:
the tracking device and the provider of the cellular and or/satellite communications network working together to have digital, analog, and GPS all built into a single tracking device.

25. The system of claim 8, further comprising:
the character display has a main menu option labeled “Set Up” or similar expression.

26. The system of claim 25, further comprising:
the tracking device allowing a user to set a delayed ignition within a unit.

27. The system of claim 1, further comprising:
first and second memory modules within each tracking device;
wherein the first memory module contains machine-specific data which differs from one unit to the next; and
the second memory module contains overall data which is globally updated across entire plurality of tracker devices

28. The system of claim 1, further comprising:
being implemented with any group of valuable mobile objects.

29. The system of claim 28, further comprising:
the valuable mobile objects being heavy equipment at construction sites

30. The system of claim 28, further comprising:
the valuable mobile objects being rental cars.

31. A method of operating a system for tracking valuable mobile objects, comprising:
attaching a tracking device to a plurality of units of the valuable mobile objects;
communicating the status of the valuable mobile objects to a tracking software module;
accessing and updating the tracking software module via end-user software; and
selectively activating the ignition of the valuable mobile objects depending on the satisfaction of specific user conditions.

32. The method of claim 31, further comprising:
querying the tracking software module to determine whether a company exists within a company database;
querying the tracking software module to determine whether a company is paid up;
querying the tracking software module to determine whether an operator is permitted to operate a specific unit of equipment;
querying the tracking software module to determine whether some other entity requested that the specific unit of equipment be shut down and inaccessible; and
enabling the ignition of the specific unit of equipment.
